(19) United States
(12) Patent Application Publication
(10) Pub. No.: US 2015/0140315 A1
(43) Pub. Date: May 21, 2015

(54) RESIN FOAM AND FOAM MATERIAL

(71) Applicant: NITTO DENKO CORPORATION, Ibaraki-shi, Osaka (JP)

(72) Inventors: Kazumichi Kato, Ibaraki-shi (JP); Makoto Saitou, Ibaraki-shi (JP); Kiyoaki Kodama, Ibaraki-shi (JP)

(73) Assignee: NITTO DENKO CORPORATION, Ibaraki-shi, Osaka (JP)

(21) Appl. No.: 14/403,850

(22) PCT Filed: May 21, 2013
(86) PCT No.: PCT/JP2013/064042

§ 371 Date: Nov. 25, 2014

(30) Foreign Application Priority Data
May 28, 2012 (JP) 2012-121292
May 17, 2013 (JP) 2013-104990

(51) Int. Cl. C08J 9/00; C09J 133/00; C09J 7/02; B29C 44/02; C08J 9/12

(52) U.S. Cl. CPC C08J 9/0061; B29C 44/02; C08J 9/122; C09J 7/0289; C09J 133/00; B29L 2031/737
USPC 428/315.7; 264/50; 521/138

(57) ABSTRACT

A resin foam having excellent dustproofness not only at ordinary temperatures but also particularly at high temperatures as well as having excellent flexibility. The resin foam has a thickness recovery ratio at high temperatures as defined below of not less than 25%, an average cell diameter of 10 to 200 μm, and a maximum cell diameter of not more than 300 μm, wherein the thickness recovery ratio at high temperatures is defined as follows: a resin foam in a sheet form is compressed, in an atmosphere of 80° C., for 22 hours in a thickness direction so as to have a thickness of 20% of the initial thickness; then, the compression state is released in an atmosphere of 23° C.; and a ratio of a thickness 24 hours after the release of the compression state to the initial thickness is defined as the thickness recovery ratio at high temperatures.

### TECHNICAL FIELD

The present invention relates to a resin foam and a foam material. More specifically, the present invention relates to a resin foam and a foam material excellent in recoverability at high temperatures, having excellent dustproofness at ordinary temperatures, and also excellent in dustproofness after storage in high-temperature environments.

### BACKGROUND ART

In electric or electronic appliances (for example, cellular phones, personal digital assistants, smart phones, tablet computers (tablet PC), digital cameras, video cameras, digital video cameras, personal computers, and household electrical appliances), a foam material [laminate obtained by laminating a pressure-sensitive adhesive layer on at least one surface side of a foamed structure (foam), a foam sealing material] has been used for fixing an image display member fixed to an image display device (display), such as a liquid crystal display (LCD), an electroluminescence display, and a plasma display, and an optical member, such as a camera and a lens, to a predetermined part (such as a fixing part).

Examples of the usage form of the foam material include a shock absorber (gasket) around a display (such as LCD) of a cellular phone (shock absorber for cellular phones). When the shock absorber for cellular phones is, for example, in a sheet form having a thickness of about 1 mm, it is punched into a framed shape having a width of 1 to 2 mm, then fixed to a container (such as a housing and a case) side with a double-sided tape, and compressed by about 20 to 80% for use. Such a usage form requires not only an essentially required function as a shock absorber to protect the breakage of a display at the falling of a cellular phone but also dustproofness and airtightness to prevent the entry of dust to a display part (for example, LCD part).

As the gasket, a gasket made of a polyurethane foam having a density of 0.3 to 0.5 g/cm³ is known (refer to Patent Literature 1). However, the gasket is for preventing the backlash of a liquid crystal display screen by suppressing the expansion ratio and has insufficient flexibility and cushioning characteristics.

Further, there is known a foam dustproofing material comprising a foam having an average cell diameter of 10 to 90 μm, a repulsive load when compressed by 50% of 0.1 to 3.0 N/cm², and an apparent density of 0.01 to 0.10 g/cm³ (refer to Patent Literature 2). Further, a thermoplastic polyester resin foam suitable for reduction in size, weight, and thickness for electric or electronic appliances has been known (refer to Patent Literature 3).

### CITATION LIST

### Patent Literature

### Patent Literature 1: Japanese Patent Laid-Open No. 2001-100216

### Patent Literature 2: Japanese Patent Laid-Open No. 2009-293043

### Patent Literature 3: Japanese Patent Laid-Open No. 2008-45120

### SUMMARY OF INVENTION

### Technical Problem

The foam dustproofing material and foam are required to have heat resistance and strain recoverability after storage in high-temperature environments in order to achieve further improvement in dustproofness. If the foam dustproofing material and foam have poor heat resistance and strain recoverability after storage in high-temperature environments, for example when equipment having a display part to which a foam dustproofing material is applied gets a shock, recovery from distortion of the foam dustproofing material may be slow; deformation of the foam dustproofing material cannot follow deformation of a display; thus, a gap may be formed between the foam dustproofing material and the display. If such a gap occurs, there is a concern of the entry of dust into the inner part of equipment when dust and the like are present. Note that in the equipment having such a display part, a foam dustproofing material will generally be used in high-temperature environments.

Further, the foam dustproofing material and foam are required to be suppressed in the occurrence of coarse cells in a cell structure and have a uniform cell structure in order to achieve further improvement in sealing properties. If the foam dustproofing material and foam have a nonuniform cell structure and contain coarse cells, the entry of dust from the coarse cells is concerned.

Therefore, an object of the present invention is to provide a resin foam having excellent dustproofness not only at ordinary temperatures but also particularly at high temperatures as well as having excellent flexibility.

Further, another object of the present invention is to provide a foam material having excellent dustproofness not only at ordinary temperatures but also particularly at high temperatures as well as having excellent flexibility.

### Solution to Problem

Thus, as a result of intensive studies, the present inventors have found that when a resin foam has a thickness recovery ratio at high temperatures of not less than a specific value, an average cell diameter within a specific range, and a maximum cell diameter of not more than a specific value, the resin foam exhibits excellent dustproofness at both ordinary temperatures and high temperatures in addition to excellent flexibility. The present invention has been completed based on these findings.

Specifically, the present invention provides a resin foam having a thickness recovery ratio at high temperatures as defined below of not less than 25%, an average cell diameter of 10 to 200 μm, and a maximum cell diameter of not more than 300 μm,

wherein the thickness recovery ratio at high temperatures is defined as follows: a resin foam in a sheet form is compressed, in an atmosphere of 80° C., for 22 hours in a thickness direction so as to have a thickness of 20% of the initial thickness; then, the compression state is released in an atmosphere of 23° C.; and a ratio of a thickness 24 hours after the release of the compression state to the initial thickness is defined as the thickness recovery ratio at high temperatures.

Further, the resin foam preferably has an apparent density of 0.01 to 0.20 g/cm³ and a repulsive force at 50% compression of 0.1 to 4.0 N/cm².

The resin constituting the resin foam is preferably a thermoplastic resin.

The thermoplastic resin is preferably polyester.

The resin foam is preferably formed through the steps of impregnating a resin composition with a high-pressure gas and subjecting the impregnated resin composition to decompression.

The resin foam is preferably formed through the steps of impregnating an unfoamed molded article comprising the resin composition with a high-pressure gas and then subjecting the impregnated unfoamed molded article to decompression to allow the unfoamed molded article to expand.

The resin foam is preferably formed through the steps of impregnating a molten resin composition with a high-pressure gas and then subjecting the impregnated resin composition to decompression to allow the resin composition to expand.

The resin foam is preferably formed by the steps of impregnating a resin composition with a high-pressure gas and then subjecting the impregnated resin composition to decompression, followed by further heating.

The gas is preferably an inert gas.

The gas is preferably carbon dioxide gas.

The high-pressure gas is preferably a gas in a supercritical state.

The present invention provides a foam material comprising the resin foam.

The foam material preferably has a pressure-sensitive adhesive layer on the resin foam.

The pressure-sensitive adhesive layer is preferably formed on the resin foam through a film layer.

The pressure-sensitive adhesive layer is preferably an acrylic pressure-sensitive adhesive layer.

### Advantageous Effects of Invention

The resin foam of the present invention has excellent dustproofness not only at ordinary temperatures but also particularly at high temperatures as well as having excellent flexibility.

Since the foam material of the present invention comprises the resin foam, the foam material has excellent dustproofness not only at ordinary temperatures but also particularly at high temperatures as well as having excellent flexibility.

### BRIEF DESCRIPTION OF DRAWINGS

FIG. 1 is a top schematic view showing a sample for measurement used for measuring dustproofness.

FIG. 2 is a sectional end view taken along line A-A′ of an evaluation container for measuring dustproofness on which a sample for measurement is mounted.

FIG. 3 is a top schematic view of an evaluation container for measuring dustproofness on which a sample for measurement is mounted.

### DESCRIPTION OF EMBODIMENTS

The resin foam of the present invention has a thickness recovery ratio at high temperatures as defined below of not less than 25%, an average cell diameter of 10 to 200 μm, and a maximum cell diameter of not more than 300 μm,

wherein the thickness recovery ratio at high temperatures is defined as follows: a resin foam in a sheet form is compressed, in an atmosphere of 80° C., for 22 hours in a thickness direction so as to have a thickness of 20% of the initial thickness; then, the compression state is released in an atmosphere of 23° C.; and a ratio of a thickness 24 hours after the release of the compression state to the initial thickness is defined as the thickness recovery ratio at high temperatures.

Note that in the present specification, the thickness recovery ratio at high temperatures defined above may be simply referred to as a “thickness recovery ratio at high temperatures.”

The resin foam of the present invention is formed by allowing a composition containing at least a resin constituting the resin foam of the present invention (resin composition) to expand. The resin composition preferably contains the resin in an amount of not less than 70% by weight (preferably not less than 80% by weight) relative to the total amount of the resin composition (100% by weight).

The thickness recovery ratio at high temperatures of the resin foam of the present invention is not less than 25%, preferably not less than 30%, more preferably not less than 40%. Since the resin foam of the present invention has a thickness recovery ratio at high temperatures of not less than 25%, it is excellent in recoverability from deformation caused by the application of a strain and excellent in dustproofness and sealing properties even in high-temperature environments (for example, in a temperature environment of 10 to 100° C.) in addition to ordinary temperature environments. Note that when recoverability is small, sealing may be insufficient to effectively prevent the entry of dust and dirt.

The average cell diameter of the resin foam of the present invention is 10 to 200 μm, more preferably 15 to 150 μm, further preferably 20 to 100 μm. Since the average cell diameter is not less than 10 μm, the resin foam of the present invention has excellent flexibility. Further, since the average cell diameter is not more than 200 μm, occurrence of pinholes can be suppressed, and the resin foam has excellent dustproofness.

The maximum cell diameter of the resin foam of the present invention is not more than 300 μm, more preferably not less than 250 μm, further preferably 200 μm. Since the maximum cell diameter is not more than 300 μm, the resin foam of the present invention is excellent in uniformity of cell structure, and since the resin foam does not contain coarse cells, a problem of entry of dust from coarse cells to reduce dustproofness can be suppressed, and the resin foam is excellent in sealing properties and dustproofness.

The cell diameter in the cell structure of the resin foam of the present invention can be determined, for example, by capturing an enlarged image of a cell-structure portion in a cut surface with a digital microscope, determining the area of the cells, and converting it to the equivalent circle diameter.

Since the resin foam of the present invention has an average cell diameter of 10 to 200 μm and a maximum cell diameter of 300 μm, the resin foam has a uniform and fine cell structure. Further, the resin foam does not contain coarse cells.

The cell structure of the resin foam of the present invention is preferably a semi-open/semi-closed cell structure for giving flexibility, but is not particularly limited thereto. The semi-open/semi-closed cell structure is a cell structure containing both a closed cell moiety and an open cell moiety, and the ratio between the closed cell moiety and the open cell moiety is not particularly limited. A cell structure in which a closed-cell moiety occupies not more than 40% (preferably not more than 30%) of the resin foam is particularly preferred.

The apparent density of the resin foam of the present invention is preferably 0.01 to 0.20 g/cm³, more preferably 0.02 to 0.17 g/cm³, further preferably 0.03 to 0.15 g/cm³, but is not particularly limited thereto. The resin foam of the present invention preferably has a density of not less than 0.01 g/cm³ because satisfactory strength can easily be obtained. Further, the resin foam of the present invention preferably has a density of not more than 0.20 g/cm³ because the resin foam has a high expansion ratio, thus capable of easily obtaining excellent flexibility. That is, when the resin foam of the present invention has an apparent density of 0.01 to 0.20 g/cm³, the resin foam will obtain better foaming characteristics (high expansion ratio) and easily exhibit proper strength, excellent flexibility, and excellent cushioning properties.

The repulsive stress at 50% compression of the resin foam of the present invention is preferably 0.1 to 4.0 N/cm², more preferably 0.3 to 3.8 N/cm², further preferably 0.5 to 3.5 N/cm², but is not particularly limited thereto. The repulsive stresses at 50% compression of the resin foam of the present invention is preferably not less than 0.1 N/cm² because the resin foam has proper rigidity, thus capable of easily obtaining good processability. Further, the repulsive stress at 50% compression of the resin foam of the present invention is preferably not more than 4.0 N/cm² because excellent flexibility can be easily obtained.

The repulsive stress at 50% compression means a compressive stress when a compression ratio is 50%. The compression ratio of 50% means compressing a resin foam in a sheet form to a state where the height of the sheet corresponding to 50% of the initial height is compressed in the thickness direction, that is, a state where the sheet is distorted by 50% from the initial thickness, and the thickness of the resin foam in a sheet form having a compression ratio of 50% corresponds to 50% of the initial thickness.

Particularly, the resin foam of the present invention preferably has an apparent density of 0.01 to 0.20 g/cm³ and a repulsive force at 50% compression of 0.1 to 4.0 N/cm² in terms of obtaining a high expansion ratio while obtaining proper strength, thus obtaining excellent flexibility and excellent sealing properties and dustproofness.

The shape of the resin foam of the present invention is preferably a sheet form and a tape form, but is not particularly limited thereto. Further, the resin foam may also be processed into a suitable shape depending on the purpose of use. For example, it may also be processed into a linear shape, a round shape, a polygonal shape, or a frame shape (framed shape) by cutting, punching, or the like.

The thickness of the resin foam of the present invention is preferably 0.05 to 3.0 mm, more preferably 0.06 to 2.8 mm, further preferably 0.07 to 1.5 mm, particularly preferably 0.08 to 1.0 mm, but is not particularly limited thereto.

The resin which is a material of the resin foam of the present invention preferably includes a thermoplastic resin, but is not particularly limited thereto. The resin foam of the present invention may comprise one resin or may comprise not less than two resins.

Examples of the thermoplastic resin include polyolefinic resins such as low density polyethylene, medium density polyethylene, high density polyethylene, linear low density polyethylene, polypropylene, a copolymer of ethylene and propylene, a copolymer of ethylene or propylene with other α-olefins (such as butene-1, pentene-1, hexene-1, and 4-methylpentene-1), a copolymer of ethylene and other ethylenic unsaturated monomers (such as vinyl acetate, acrylic acid, acrylate, methacrylic acid, methacrylate, and vinyl alcohol); styrenic resins such as polystyrene and an acrylonitrile-butadiene-styrene copolymer (ABS resin); polyamide resins such as 6-nylon, 66-nylon, and 12-nylon; polyamideimide; polyurethane; polyimide; polyether imide; acrylic resins such as polymethylmethacrylate; polyvinyl chloride; polyvinyl fluoride; alkenyl aromatic resin; polyester resins such as polyethylene terephthalate and polybutylene terephthalate; polycarbonate such as bisphenol A polycarbonate; polyacetal; and polyphenylene sulfide. Further, the thermoplastic resin may be used alone or in combination. Note that when the thermoplastic resin is a copolymer, it may be a copolymer in the form of a random copolymer or a block copolymer.

The thermoplastic resin also includes a rubber component and/or a thermoplastic elastomer component. The rubber component and thermoplastic elastomer component have a glass transition temperature of equal to or lower than room temperature (for example, not more than 20° C.), and therefore, when the component is formed into a resin foam, the resulting foam is significantly excellent in flexibility and shape conformability. Note that the resin foam of the present invention may be formed from a resin composition containing the thermoplastic resin and a rubber component and/or a thermoplastic elastomer component.

The rubber component or thermoplastic elastomer component is not particularly limited as long as it has rubber elasticity and can be expanded, and examples thereof include various thermoplastic elastomers such as natural or synthetic rubber such as natural rubber, polyisobutylene, polyisoprene, chloroprene rubber, butyl rubber, and nitrile butyl rubber; olefinic elastomers such as ethylene-propylene copolymers, ethylene-propylene-diene copolymers, ethylene-vinylacetate copolymers, polybutene, and chlorinated polyethylene; styrenic elastomers such as styrene-butadiene-styrene copolymers, styrene-isoprene-styrene copolymers, and hydrogenated polymers derived from them; polyester elastomers; polyamide elastomers; and polyurethane elastomers. Note that these rubber components and/or thermoplastic elastomer components may be used alone or in combination.

The thermoplastic resin is preferably polyester (polyester such as the polyester resin and the polyester elastomer as described above), more preferably a polyester elastomer, in terms of obtaining a thickness recovery ratio at high temperatures of not less than a specific value, an average cell diameter within a specific range, and a maximum cell diameter of not more than a specific value, thereby obtaining excellent dustproofness at both ordinary temperatures and high temperatures and excellent flexibility. That is, the resin foam of the present invention is more preferably a resin foam formed from a resin composition containing a polyester elastomer (polyester elastomer foam).

The polyester elastomer is not particularly limited as long as it is a resin having an ester binding site derived from a reaction (polycondensation) of a polyol component with a polycarboxylic acid component. Examples of the polyester elastomer include a polyester thermoplastic resin obtained by polycondensation of an aromatic dicarboxylic acid (divalent aromatic carboxylic acid) with a diol component.

Examples of the aromatic dicarboxylic acid include terephthalic acid, isophthalic acid, phthalic acid, naphthalene carboxylic acid (such as 2,6-naphthalene dicarboxylic acid, 1,4-naphthalene dicarboxylic acid), diphenyl ether dicarboxylic acid, and 4,4-biphenyl dicarboxylic acid. Note that the aromatic dicarboxylic acid may be used alone or in combination.

Further, examples of the diol component include aliphatic diols such as ethylene glycol, propylene glycol, trimethylene glycol, 1,4-butanediol (tetramethylene glycol), 2-methyl-1,3-propanediol, 1,5-pentanediol, 2,2-dimethyl-1,3-propanediol (neopentyl glycol), 1,6-hexanediol, 3-methyl-1,5-pentanediol, 2-methyl-2,4-pentanediol, 1,7-heptane diol, 2,2-diethyl-1,3-propanediol, 2-methyl-2-propyl-1,3-propanediol, 2-methyl-1,6-hexanediol, 1,8-octanediol, 2-butyl-2-ethyl-1,3-propanediol, 1,3,5-trimethyl-1,3-pentanediol, 1,9-nonanediol, 2,4-diethyl-1,5-pentanediol, 2-methyl-1,8-octanediol, 1,10-decanediol, 2-methyl-1,9-nonanediol, 1,18-octadecanediol, and dimer diol; alicyclic diols such as 1,4-cyclohexanediol, 1,3-cyclohexanediol, 1,2-cyclohexanediol, 1,4-cyclohexanedimethanol, 1,3-cyclohexanedimethanol, and 1,2-cyclohexanedimethanol; aromatic diols such as bisphenol A, an ethylene oxide adduct of bisphenol A, bisphenol S, an ethylene oxide adduct of bisphenol S, xylylene diol, and naphthalenediol; ether glycols such as diethylene glycol, triethylene glycol, tetraethylene glycol, polyethylene glycol, and dipropylene glycol. Note that the diol component may be a diol component in a polymer form such as a polyether diol and a polyester diol. Examples of the polyetherdiols include polyethylene glycol, polypropylene glycol, and polytetramethylene glycol obtained by ring opening polymerization of ethylene oxide, propylene oxide, and tetrahydrofuran, respectively, and polyetherdiols such as copolyethers obtained by copolymerization of these monomers. Further, the diol component may be used alone or in combination.

Examples of the polyester thermoplastic resin include polyalkylene terephthalate resins such as polyethylene terephthalate, polytrimethylene terephthalate, polybutylene terephthalate, polyethylene naphthalate, polybutylene naphthalate, and polycyclohexane terephthalate. Other examples of the polyester thermoplastic resin also includes a copolymer obtained by copolymerizing two or more of the polyalkylene terephthalate resins. Note that when the polyalkylene terephthalate resin is a copolymer, it may be a copolymer in the form of a random copolymer, a block copolymer, or a graft copolymer.

Further, examples of a polyester elastomer include a polyester elastomer which is a block copolymer of a hard segment and a soft segment.

Examples of such a polyester elastomer (polyester elastomer which is a block copolymer of a hard segment and a soft segment) include (i) a polyester-polyester type copolymer containing, as a hard segment, a polyester formed by polycondensation of the aromatic dicarboxylic acid with a diol component having 2 to 4 carbon atoms between the hydroxyl groups in the main chain among the diol components and containing, as a soft segment, a polyester formed by polycondensation of the aromatic dicarboxylic acid with a diol component having 5 or more carbon atoms between the hydroxyl groups in the main chain among the diol components; (ii) a polyester-polyether type copolymer containing the same polyester as in the above (i) as a hard segment and containing a polyether such as the above polyetherdiols as a soft segment; and (iii) a polyester-polyester type copolymer containing the same polyester as in the above (i) and (ii) as a hard segment and containing an aliphatic polyester as a soft segment.

Particularly, when the resin foam of the present invention is a polyester elastomer foam, the polyester elastomer constituting the foam is preferably a polyester elastomer which is a block copolymer of a hard segment and a soft segment, more preferably the above (ii) polyester-polyether type copolymer (a polyester-polyether type copolymer containing, as a hard segment, a polyester formed by polycondensation of an aromatic dicarboxylic acid with a diol component having 2 to 4 carbon atoms between the hydroxyl groups in the main chain, and containing a polyether as a soft segment).

More specific examples of the above (ii) polyester-polyether type copolymer include a polyester-polyether type block copolymer having polybutylene terephthalate as a hard segment and a polyether as a soft segment.

The melt flow rate (MFR) at 230° C. of a resin constituting the resin foam of the present invention is preferably 1.5 to 4.0 g/10 min, more preferably 1.5 to 3.8 g/10 min, further preferably 1.5 to 3.5 g/10 min, but is not particularly limited thereto. The melt flow rate (MFR) at 230° C. of the resin is preferably not less than 1.5 g/10 min because the moldability of the resin composition used for forming the resin foam of the present invention is improved. Further, the melt flow rate (MFR) at 230° C. of the resin is preferably not more than 4.0 g/10 min because the variation in the cell diameter hardly occurs after the formation of a cell structure, and a uniform cell structure is easily obtained. Note that, in the present specification, the MFR at 230° C. refers to an MFR measured at a temperature of 230° C. and a load of 2.16 kgf based on ISO1133 (JIS K 7210).

That is, the resin foam of the present invention is preferably formed from a resin composition containing a resin having a melt flow rate (MFR) at 230° C. of 1.5 to 4.0 g/10 min. Particularly, when the resin foam of the present invention is a polyester elastomer foam, the resin foam is preferably formed from a resin composition containing a polyester elastomer (particularly, a polyester elastomer which is a block copolymer of a hard segment and a soft segment) having a melt flow rate (MFR) at 230° C. of 1.5 to 4.0 g/10 min.

The resin composition forming the resin foam of the present invention preferably contains a foam nucleating agent in addition to the resin as described above. When the resin composition contains a foam nucleating agent, a resin foam in a good foamed state can be easily obtained. Note that the foam nucleating agent may be used alone or in combination.

The foam nucleating agent preferably includes an inorganic substance, but is not particularly limited thereto. Examples of the inorganic substance include hydroxides such as aluminum hydroxide, potassium hydroxide, calcium hydroxide, and magnesium hydroxide; clay (particularly hard clay); talc; silica; zeolite; alkaline earth metal carbonates such as calcium carbonate and magnesium carbonate; metal oxides such as zinc oxide, titanium oxide, and alumina; metal powder such as various metal powder such as iron powder, copper powder, aluminum powder, nickel powder, zinc powder, and titanium powder, and alloy powder; mica; carbon particles; glass fiber; carbon tubes; laminar silicates; and glass.

Especially, as an inorganic substance as a foam nucleating agent, clay and alkaline earth metal carbonates are preferred, and hard clay is more preferred, in terms of suppressing the occurrence of coarse cells and capable of easily obtaining a uniform and fine cell structure.

The hard clay is clay containing substantially no coarse particles. In particular, the hard clay is preferably clay having a residue on a 166 mesh sieve of not more than 0.01%, and more preferably clay having a residue on a 166 mesh sieve of not more than 0.001%. Note that the residue on sieve refers to the proportion (based on weight) of particles remaining on a sieve without passing through it when the particles are sieved to the total particles.

The hard clay includes aluminum oxide and silicon oxide as essential components. The proportion of the sum of the aluminum oxide and the silicon oxide in the hard clay is preferably not less than 80% by weight (for example, 80 to 100% by weight), more preferably not less than 90% by weight (for example, 90 to 100% by weight) relative to the total amount (100% by weight) of the hard clay. Further, the hard clay may be fired.

The average particle size of the hard clay is preferably 0.1 to 10 μm, more preferably 0.2 to 5.0 μm, further preferably 0.5 to 1.0 μm, but is not limited thereto.

Further, the inorganic substance is preferably subjected to surface treatment. That is, the foam nucleating agent is preferably a surface-treated inorganic substance. Examples of surface treatment agents used for the surface treatment of the inorganic substance preferably include, but are not particularly limited to, aluminum compounds, silane compounds, titanate compounds, epoxy compounds, isocyanate compounds, higher fatty acids or salts thereof, and phosphoric esters, more preferably include silane compounds (particularly, silane coupling agents) and higher fatty acids or salts thereof (particularly, stearic acid), in terms of obtaining such an effect that application of surface treatment improves compatibility with a resin (particularly, polyester) to thereby prevent occurrence of voids during expansion, molding, kneading, drawing, or the like or prevent rupture of cells during expansion. Note that the surface treatment agent may be used alone or in combination.

That is, it is particularly preferred that the surface treatment of the inorganic substance be silane coupling treatment or treatment with a higher fatty acid or a salt thereof.

The aluminum compound is preferably, but not limited to, an aluminate coupling agent. Examples of the aluminate coupling agent include acetoalkoxy aluminum diisopropylate, aluminum ethylate, aluminum isopropylate, mono-sec-butoxy aluminum diisopropylate, aluminum sec-butyrate, ethyl acetoacetate aluminum diisopropylate, aluminum tris(ethyl acetoacetate), aluminum mono-acetylacetonate bis(ethyl acetoacetate), aluminum tris(acetylacetonate), a cyclic aluminum oxide isopropylate, and a cyclic aluminum oxide isostearate.

The silane compound is preferably, but not limited to, a silane coupling agent. Examples of the silane coupling agent include a vinyl group-containing silane coupling agent, a (meth)acryloyl group-containing silane coupling agent, an amino group-containing silane coupling agent, an epoxy group-containing silane coupling agent, a mercapto group-containing silane coupling agent, a carboxyl group-containing silane coupling agent, and a halogen atom-containing silane coupling agent. Specific examples of the silane coupling agent include vinyltrimethoxysilane, vinylethoxysilane, dimethylvinylmethoxysilane, dimethylvinylethoxysilane, methylvinyldimethoxysilane, methylvinyldiethoxysilane, vinyl-tris(2-methoxy)silane, vinyltriacetoxysilane, 2-methacryloxyethyltriethoxysilane, 3-methacryloxypropyltrimethoxysilane, 3-methacryloxypropyltriethoxysilane, 3-methacryloxypropylmethyldimethoxysilane, 3-aminopropyltrimethoxysilane, 3-aminopropyltriethoxysilane, 2-aminoethyltrimethoxysilane, 3-[N-(2-aminoethyl)amino]propyltrimethoxysilane, 3-[N-(2-aminoethyl)amino]propyltriethoxysilane, 2-[N-(2-aminoethyl)amino]ethyltrimethoxysilane, 2-(3,4-epoxycyclohexyl)ethyltrimethoxysilane, 2-(3,4-epoxycyclohexyl)ethyltriethoxysilane, 3-glycidoxypropyltrimethoxysilane, 3-glycidoxypropylmethyldiethoxysilane, 2-glycidoxyethyltrimethoxysilane, 2-glycidoxyethyltriethoxysilane, 3-mercaptopropyltrimethoxysilane, carboxymethyltriethoxysilane, 3-carboxypropyltrimethoxysilane, and 3-carboxypropyltriethoxysilane.

The titanate compound is preferably, but not limited to, a titanate coupling agent. Examples of the titanate coupling agent include isopropyl triisostearoyl titanate, isopropyl tris(dioctylpyrophosphate)titanate, isopropyl tri(N-aminoethyl-aminoethyl)titanate, isopropyl tridecylbenzenesulphonyl titanate, tetraisopropyl bis(dioctylphosphite)titanate, tetraoctyl bis(ditridecylphosphite)titanate, tetra(2,2-diallyloxymethyl-1-butyl)bis(di-tridecyl)phosphite titanate, bis(dioctylpyrophosphate)oxyacetate titanate, bis(dioctylpyrophosphate)ethylene titanate, isopropyl trioctanoyl titanate, isopropyl dimethacryl isostearoyl titanate, isopropyl isostearoyl diacryl titanate, isopropyl tri(dioctylphosphate)titanate, isopropyl tricumylphenyl titanate, dicumylphenyloxyacetate titanate, and diisostearoylethylene titanate.

The epoxy compound is preferably, but not limited to, an epoxy resin and a mono-epoxy compound. Examples of the epoxy resin include a glycidyl ether type epoxy resin such as a bisphenol A type epoxy resin, a glycidyl ester type epoxy resin, a glycidyl amine type epoxy resin, and an alicyclic epoxy resin. Further, examples of the mono-epoxy compound include styrene oxide, glycidyl phenyl ether, allyl glycidyl ether, glycidyl(meth)acrylate, 1,2-epoxycyclohexane, epichlorohydrin, and glycidol.

The isocyanate compound is preferably, but not limited to, a polyisocyanate compound and a monoisocyanate compound. Examples of the polyisocyanate compound include an aliphatic diisocyanate such as tetramethylene diisocyanate and hexamethylene diisocyanate; an alicyclic diisocyanate such as isophorone diisocyanate and 4,4′-dicyclohexylmethane diisocyanate; an aromatic diisocyanate such as diphenylmethane diisocyanate, 2,4-tolylene diisocyanate, 2,6-tolylene diisocyanate, phenylene diisocyanate, 1,5-naphthylene diisocyanate, xylylene diisocyanate, and toluylene diisocyanate; and a polymer having a free isocyanate group derived from a reaction of the above diisocyanate compound with a polyol compound. Further, examples of the monoisocyanate compound include phenyl isocyanate and stearyl isocyanate.

Examples of the higher fatty acid or a salt thereof include a higher fatty acid such as oleic acid, stearic acid, palmitic acid, and lauric acid, and a salt (for example, a metal salt and the like) of the higher fatty acid. Examples of the metal atom in the metal salt of the higher fatty acid include an alkali metal atom such as a sodium atom and a potassium atom and an alkali earth metal atom such as a magnesium atom and a calcium atom.

The phosphoric acid esters are preferably phosphoric acid partial esters. Examples of the phosphoric acid partial esters include a phosphoric acid partial ester in which phosphoric acid (orthophosphoric acid or the like) is partially esterified (mono- or di-esterified) with an alcohol component (stearyl alcohol or the like) and a salt (such as a metal salt with an alkali metal or the like) of the phosphoric acid partial ester.

Examples of the process for the surface treatment of the inorganic substances with the surface treatment agent include, but are not limited to, a dry process, a wet process, and an integral blending process. Further, the amount of the surface treatment agent in the surface treatment of the inorganic substance with the surface treatment agent is preferably 0.1 to 10 parts by weight, more preferably 0.3 to 8 parts by weight relative to 100 parts by weight of the above inorganic substance, but is not limited thereto.

Further, the residue on a 166 mesh sieve of the inorganic substance is preferably not more than 0.01%, more preferably not more than 0.001%, but is not limited thereto. This is because if coarse particles are present when a resin composition is allowed to expand, the rupture of cells can easily occur. This is because the size of the particles exceeds the thickness of the cell wall.

The average particle size of the inorganic substance is preferably 0.1 to 10 μm, more preferably 0.2 to 5.0 μm, further preferably 0.5 to 1.0 μm, but is not limited thereto. If the average particle size is less than 0.1 μm, the inorganic substance may not sufficiently function as a nucleating agent. On the other hand, if the average particle size exceeds 10 μm, it may cause outgassing during foaming of a resin composition. Therefore, these average particle sizes are not preferred.

Particularly, the foam nucleating agent is preferably a surface-treated inorganic substance (particularly, a surface-treated hard clay), in terms of compatibility with a resin and capable of easily obtaining a fine cell structure by suppressing the foam rupture during foaming due to the occurrence of voids at the interface between a resin and an inorganic substance.

The content of the foam nucleating agent in the resin composition is preferably 0.1 to 20% by weight, more preferably 0.1 to 15% by weight, further preferably 0.3 to 10% by weight, relative to the total amount (100% by weight) of the resin composition, but is not limited thereto. The content is preferably not less than 0.1% by weight because the occurrence of coarse cells is prevented, and a resin foam having a uniform and fine cell structure is easily obtained. Further, the content is preferably not more than 20% by weight because a significant increase in the viscosity of a resin composition can be suppressed; outgassing during the foaming of a resin composition can be suppressed; and a uniform cell structure is easily obtained.

Further, the resin composition preferably contains an epoxy-modified polymer. The epoxy-modified polymer acts as a crosslinking agent. It also acts as a modifier (resin modifier) for improving the melt tension and the degree of strain hardening of a resin composition (particularly, a resin composition containing a polyester elastomer). Therefore, when the resin composition contains the epoxy-modified polymer, a thickness recovery ratio at high temperatures of not less than a specified value is obtained, thereby easily obtaining excellent dustproofness and easily obtaining a highly-expanded, fine, uniform cell structure. Note that an epoxy-modified polymer may be used alone or in combination.

The epoxy-modified polymer is preferably, but not particularly limited to, at least one polymer selected from an epoxy-modified acrylic polymer which is a polymer having an epoxy group in a terminal of the main chain and a side chain of an acrylic polymer and an epoxy-modified polyethylene which is a polymer having an epoxy group in a terminal of the main chain and a side chain of polyethylene, in terms of hardly forming a three-dimensional network as compared with a low molecular weight compound having an epoxy group and capable of easily obtaining a resin composition (particularly, a resin composition containing a polyester elastomer) excellent in melt tension and the degree of strain hardening.

The weight average molecular weight of the epoxy-modified polymer is preferably 5,000 to 100,000, more preferably 8,000 to 80,000, further preferably 10,000 to 60,000, particularly preferably 20,000 to 60,000, but is not particularly limited thereto. Note that if the molecular weight is less than 5,000, the reactivity of the epoxy-modified polymer may increase, and a resin composition may not be highly expanded.

The epoxy equivalent of the epoxy-modified polymer is preferably 100 to 3000 g/eq, more preferably 200 to 2500 g/eq, further preferably 300 to 2000 g/eq, particularly preferably 800 to 1600 g/eq, but is not particularly limited thereto. The epoxy equivalent of the epoxy-modified polymer is preferably not more than 3000 g/eq because the melt tension and the degree of strain hardening of a resin composition (particularly, a resin composition containing a polyester elastomer) can be sufficiently improved to obtain a thickness recovery ratio at high temperatures of not less than a specified value, and thereby, dustproofness is easily improved and a highly-expanded fine cell structure is easily obtained. Further, the epoxy equivalent of the epoxy-modified polymer is preferably not less than 100 g/eq because this can suppress a problem that the reactivity of the epoxy-modified polymer is increased to excessively increase the viscosity of the resin composition to prevent the resin composition from being highly expanded.

The viscosity (B type viscosity, 25° C.) of the epoxy-modified polymer is preferably 2000 to 4000 mPa·s, more preferably 2500 to 3200 mPa·s, but is not particularly limited thereto. The viscosity of the epoxy-modified polymer is preferably 2000 mPa·s because the failure of the cell wall during foaming of a resin composition is suppressed, and a highly-expanded fine cell structure is easily obtained. On the other hand, the viscosity is preferably not more than 4000 mPa·s because the fluidity of the resin composition is easily obtained, and the resin composition can be efficiently expanded.

Particularly, the epoxy-modified polymer preferably has a weight average molecular weight of 5,000 to 100,000 and an epoxy equivalent of 100 to 3000 g/eq.

The content of the epoxy-modified polymer in the resin composition is preferably 0.5 to 15.0 parts by weight, more preferably 0.6 to 10.0 parts by weight, further preferably 0.7 to 7.0 parts by weight, particularly preferably 0.8 to 3.0 parts by weight, relative to 100 parts by weight of the resin in the resin composition, but is not particularly limited thereto. The content of the epoxy-modified polymer is preferably not less than 0.5 parts by weight because the melt tension and the degree of strain hardening of a resin composition can be increased, and thereby, a highly-expanded fine cell structure is easily obtained. Further, the content of the epoxy-modified polymer is preferably not more than 15.0 parts by weight because this can suppress a problem that the viscosity of a resin composition is excessively increased to prevent the composition from being highly expanded, and a highly-expanded fine cell structure is easily obtained.

Note that the epoxy-modified polymer can further improve the melt tension of a resin composition containing a polyester elastomer because the polymer can inhibit the cleavage of a polyester chain by hydrolysis (for example, hydrolysis resulting from moisture absorption of a raw material), thermal decomposition, oxidative decomposition, and the like, and can recombine the cleaved polyester chain. Further, since the epoxy-modified polymer has a large number of epoxy groups in a molecule, it can more easily allow a branched structure to be formed than a conventional epoxy crosslinking agent, and can further improve the degree of strain hardening of a resin composition containing a polyester elastomer.

Further, the resin composition preferably contains a lubricant. The resin composition preferably contains a lubricant because the moldability of a resin composition is improved. The resin composition preferably has improved slidability and, for example, can be preferably easily extruded from an extruder into a desired shape without clogging. Note that the lubricant may be used alone or in combination.

Examples of the lubricant include, but are not particularly limited to, aliphatic carboxylic acids and derivatives thereof (for example, aliphatic carboxylic acid anhydrides, alkali metal salts of aliphatic carboxylic acids, and alkaline earth metal salts of aliphatic carboxylic acids). Among the aliphatic carboxylic acids and derivatives thereof, especially preferred are aliphatic carboxylic acids having 3 to 30 carbon atoms such as lauryl acid and derivatives thereof, stearic acid and derivatives thereof, crotonic acid and derivatives thereof, oleic acid and derivatives thereof, maleic acid and derivatives thereof, glutaric acid and derivatives thereof, behenic acid and derivatives thereof, and montanic acid and derivatives thereof. Further, among the aliphatic carboxylic acids having 3 to 30 carbon atoms and derivatives thereof, stearic acid and derivatives thereof and montanic acid and derivatives thereof are preferred, and alkali metal salts of stearic acid and alkaline earth metal salts of stearic acid are particularly preferred, in terms of dispersibility and solubility in the resin composition and the effect of improvement in surface appearance. Furthermore, zinc stearate and calcium stearate are more suitable among alkali metal salts of stearic acid and alkaline earth metal salts of stearic acid.

In addition, the lubricant includes an acrylic lubricant. Examples of commercially available products of the acrylic lubricant include an acrylic polymer external lubricant (trade name “Metablen L”, supplied by Mitsubishi Rayon Co., Ltd.).

Particularly, an acrylic lubricant is preferred as the lubricant.

The content of the lubricant in the resin composition is preferably 0.1 to 20 parts by weight, more preferably 0.1 to 17 parts by weight, further preferably 0.5 to 10 parts by weight, relative to 100 parts by weight of the resin in the resin composition, but is not particularly limited thereto. The content of the lubricant is preferably not less than 0.1 parts by weight because it is easy to obtain the effect obtained by containing the lubricant. On the other hand, the content of the lubricant is preferably not more than 20 parts by weight because this suppresses the omission of cells when the resin composition is allowed to expand, and can suppress a problem that the resin composition cannot be highly expanded.

A crosslinking agent may be contained in the resin composition within the range that does not impair the effects of the present invention. Examples of the crosslinking agent include, but not limited to, an epoxy crosslinking agent, an isocyanate crosslinking agent, a silanol crosslinking agent, a melamine resin crosslinking agent, a metal salt crosslinking agent, a metal chelate crosslinking agent, and an amino resin crosslinking agent. Note that the crosslinking agent may be used alone or in combination.

The resin composition may further contain a crystallization promoter within the range which does not prevent the effects of the present invention. Examples of the crystallization promoter include, but are not particularly limited to, an olefinic resin. Preferred ones among such olefinic resins include a resin of a type having a wide molecular weight distribution with a shoulder on the high molecular weight side, a slightly crosslinked type resin (a resin of a type crosslinked a little), and a long-chain branched type resin. Examples of the olefinic resins include low density polyethylene, medium density polyethylene, high density polyethylene, linear low density polyethylene, polypropylene, a copolymer of ethylene and propylene, a copolymer of ethylene or propylene and another alpha olefin (such as butene-1, pentene-1, hexene-1, and 4-methylpentene-1), and a copolymer of ethylene and another ethylenic unsaturated monomer (such as vinyl acetate, acrylic acid, acrylate, methacrylic acid, methacrylate, and vinyl alcohol). Note that when the olefinic resin is a copolymer, the copolymer may be in either form of a random copolymer or a block copolymer. Further, the olefinic resin may be used alone or in combination.

Further, the resin composition may contain a flame retardant within the range that does not impair the effects of the present invention. This is because although the resin foam of the present invention has the characteristics of easy burning since it contains a resin, the resin foam may be used for applications in which it is indispensable to impart flame retardancy such as electric appliance or electronic appliance application. Examples of the flame retardant include, but are not particularly limited to, powder particles having flame retardancy (such as various powdery flame retardants), and preferably include inorganic flame retardants. Examples of the inorganic flame retardants may include brominated flame retardants, chlorine-based flame retardants, phosphorus flame retardants, and antimony flame retardants. However, chlorine-based flame retardants and brominated flame retardants generate a gas component which is harmful to a human body and corrosive to equipment when it burns, and phosphorus flame retardants and antimony flame retardants have problems such as harmfulness and explosibility. Therefore, non-halogen non-antimony inorganic flame retardants (inorganic flame retardants in which halogenated compounds and antimony compounds are not contained) are preferred. Examples of the non-halogen non-antimony inorganic flame retardants include hydrated metal compounds such as aluminum hydroxide, magnesium hydroxide, a magnesium oxide/nickel oxide hydrate, and a magnesium oxide/zinc oxide hydrate. Note that the hydrated metal oxides may be surface-treated. The flame retardant may be used alone or in combination.

Further, the following additives may be optionally contained in the resin composition within the range that does not impair the effects of the present invention. Examples of such additives include crystal nucleators, plasticizers, colorants (carbon black aiming at black color, pigments, and dyestuffs, and the like), ultraviolet absorbers, antioxidants, age inhibitors, reinforcements, antistatic agents, surfactants, tension modifiers, shrink resistant agents, fluidity improving agents, vulcanizing agents, surface-treating agents, dispersing aids, and polyester resin modifiers. Further, the additives may be used alone or in combination.

Particularly, the resin composition preferably contains at least the following (i) to (iv) in terms of obtaining a thickness recovery ratio at high temperatures of not less than a specific value, an average cell diameter within a specific range, and a maximum cell diameter of not more than a specific value, thereby obtaining excellent dustproofness at both ordinary temperatures and high temperatures and excellent flexibility.

(i): a polyester elastomer having a melt flow rate (MFR) at 230° C. of 1.5 to 4.0 g/10 min (preferably a polyester elastomer having a melt flow rate (MFR) at 230° C. of 1.5 to 4.0 g/10 min which is a block copolymer of a hard segment and a soft segment, more preferably a polyester-polyether type copolymer having a melt flow rate (MFR) at 230° C. of 1.5 to 4.0 g/10 min and containing, as a hard segment, a polyester formed by polycondensation of an aromatic dicarboxylic acid with a diol component having 2 to 4 carbon atoms between the hydroxyl groups in the main chain, and containing a polyether as a soft segment)

(ii): an epoxy-modified polymer

(iii): a lubricant (preferably an acrylic lubricant)

(iv): a foam nucleating agent (preferably a surface-treated inorganic substance, more preferably a surface-treated hard clay)

The resin composition is prepared, for example, by mixing the resin, the additives optionally added, and the like. The way to prepare the composition, however, is not limited to this. Note that heat may be applied at the time of the preparation.

The melt tension (take-up speed: 2.0 m/min) of the resin composition is preferably 15 to 70 cN, more preferably 13 to 60 cN, further preferably 15 to 55 cN, particularly preferably 26 to 50 cN, but is not particularly limited thereto. If the melt tension of the resin composition is less than 10 cN, when the resin composition is allowed to expand, the expansion ratio will be low; closed-cells will not be easily formed; and the shape of the cells formed will not be easily uniformized. On the other hand, if the melt tension of the resin composition is more than 70 cN, the fluidity may be reduced to have a bad influence on foaming.

Note that melt tension refers to a tension obtained when a molten resin extruded at a specified temperature and extrusion speed from a specified die using a specified apparatus is taken up into a strand shape at a specified take-up speed. In the present invention, the melt tension is defined as a value obtained when a resin extruded at a constant speed of 8.8 mm/min from a capillary having a diameter of 2 mm and a length of 20 mm using Capillary Extrusion Rheometer supplied from Malvern Instruments Ltd. is taken up at a take-up speed of 2 m/min.

Note that melt tension is a value measured at a temperature that is higher by 10±2° C. than the melting point of the resin in the resin composition. This is because the resin will not be in a molten state at a temperature less than the melting point; on the other hand, the resin will be in a complete liquid state at a temperature that is significantly higher than the melting point; and the melt tension cannot be measured.

The degree of strain hardening (strain rate: 0.1 [1/s]) of the resin compositions is preferably 2.0 to 5.0, more preferably 2.5 to 4.5, in terms of having a uniform and dense cell structure and suppressing rupture of cells during the expansion to obtain a highly expanded foam, but is not particularly limited thereto. Further, the degree of strain hardening of the resin composition is the degree of strain hardening at the melting point of the resin in the resin composition. Note that the degree of strain hardening is an index showing the degree of the increase in the uniaxial elongational viscosity in the measurement of the uniaxial elongational viscosity, in the region (nonlinear region) where the uniaxial elongational viscosity has risen, separated from the region (linear region) where the uniaxial elongational viscosity gradually increases with the increase in strain after starting the measurement.

The resin foam of the present invention is preferably formed by subjecting the resin composition to foam molding. A process for foaming the resin composition preferably includes, but is not limited to, a foaming process comprising impregnating a resin composition with a high-pressure gas and then subjecting the impregnated resin composition to decompression (pressure relief). That is, the resin foam of the present invention is preferably formed through the steps of impregnating the resin composition with a high-pressure gas and then subjecting the impregnated resin composition to decompression.

The gas is preferably an inert gas in terms of obtaining a clean resin foam. The inert gas refers to a gas which is inert to a resin composition and with which a resin composition can be impregnated. Note that these gases may be mixed and used.

Note that the process for foaming a resin composition includes a physical foaming technique (foaming process using a physical technique) and a chemical foaming technique (foaming process using a chemical technique). If foaming is performed according to the physical technique, there may occur problems about the combustibility, toxicity, and influence on the environment such as ozone layer depletion of the substance used as a blowing agent (blowing agent gas). However, the foaming technique using an inert gas is an environmentally friendly technique in that the blowing agent as described above is not used. If foaming is performed according to the chemical technique, a residue of a blowing gas produced from the blowing agent remains in the foam. This may cause a trouble of contamination by a corrosive gas or impurities in the gas especially in electronic appliances where suppression of contamination is highly needed. However, according to the foaming technique using an inert gas, a clean foam without such impurities and the like can be obtained. In addition, the physical and chemical foaming techniques are believed to be difficult to give a micro cell structure and to be very difficult to give micro cells of not more than 300 μm.

Examples of the inert gas include, but are not limited to, carbon dioxide (carbonic acid gas), nitrogen gas, helium, and air. Among these, carbon dioxide is preferred in that it can be impregnated in a large amount and at a high rate into the resin composition.

Further, from the viewpoint of increasing the rate of impregnation into a resin composition, the high-pressure gas is preferably in a supercritical state. Such gas in a supercritical state shows increased solubility in a resin composition and can be incorporated therein in a higher concentration. In addition, because of its high concentration, the supercritical gas generates a larger number of cell nuclei upon an abrupt pressure drop after impregnation. These cell nuclei grow to give cells, which are present in a higher density than in a foam having the same porosity but produced with the gas in another state. Consequently, use of a supercritical gas can give micro cells. Note that the critical temperature and critical pressure of carbon dioxide are 31° C. and 7.4 MPa, respectively.

As described above, the resin foam of the present invention is preferably produced by impregnating a resin composition with a high-pressure gas. The production may be performed by a batch system or continuous system. In the batch system, a resin composition is previously molded into an unfoamed resin molded article (unfoamed molded article) in an adequate form such as a sheet form, and then the unfoamed resin molded article is impregnated with a high-pressure gas, and the unfoamed resin molded article is then released from the pressure to allow the molded article to expand. In the continuous system, a resin composition is kneaded under a pressure together with a high-pressure gas, and the kneaded mixture is molded into a molded article and, simultaneously, is released from the pressure. Thus, molding and foaming are performed simultaneously in the continuous system.

A case where the resin foam of the present invention is produced by a batch system will be described. In the batch system, an unfoamed resin molded article is first produced when the resin foam is produced. Examples of the process for producing the unfoamed resin molded article include, but are not particularly limited to, a process in which a resin composition is extruded with an extruder such as a single-screw extruder or twin-screw extruder; a process in which a resin composition is uniformly kneaded beforehand with a kneading machine equipped with one or more blades typically of a roller, cam, kneader, or Banbury type, and the resulting mixture is press-molded typically with a hot-plate press to thereby produce an unfoamed resin molded article having a predetermined thickness; and a process in which a resin composition is molded with an injection molding machine. It is preferred to select a suitable process to give an unfoamed resin molded article having a desired shape and thickness among these processes. Note that the unfoamed resin molded article may be produced by other forming process in addition to extrusion, press molding, and injection molding. Further, with respect to the shape of the unfoamed resin molded article, various shapes are selected depending on applications, in addition to a sheet form. Examples of the shape include a sheet form, roll form, prism form, and plate form. Next, cells are formed through a gas impregnation step of putting the unfoamed resin molded article (molded article of a resin composition) in a pressure-tight vessel (high pressure vessel) and injecting (introducing) a high-pressure gas to impregnate the unfoamed resin molded article with the high-pressure gas; a decompression step of releasing the pressure (typically, to atmospheric pressure) when the unfoamed resin molded article is sufficiently impregnated with the high-pressure gas to allow cell nuclei to be generated in the unfoamed resin molded article; and optionally (where necessary) a heating step of heating the unfoamed resin molded article to allow the cell nuclei to grow. Note that the cell nuclei may be allowed to grow at room temperature without providing the heating step. After the cells are allowed to grow in this way, the unfoamed resin molded article is rapidly cooled with cold water as needed to fix its shape to yield the resin foam. Note that the introduction of the high-pressure gas may be performed continuously or discontinuously. The heating for the growth of cell nuclei can be performed according to a known or common procedure such as heating with a water bath, oil bath, hot roll, hot-air oven, far-infrared rays, near-infrared rays, or microwaves.

That is, the resin foam of the present invention may be formed by allowing it to expand through the steps of impregnating the unfoamed molded article comprising the resin composition with a high-pressure gas and then subjecting the impregnated unfoamed molded article to decompression. Further, the resin foam of the present invention may be formed through the steps of impregnating the unfoamed molded article comprising the resin composition with a high-pressure gas and then subjecting the impregnated unfoamed molded article to decompression, followed by heating the decompressed molded article.

On the other hand, examples of the case where the resin foam is produced by a continuous system include the production by a kneading/impregnation step of kneading a resin composition with an extruder such as a single-screw extruder or twin-screw extruder and, during this kneading, injecting (introducing) a high-pressure gas to impregnate a resin composition with the gas sufficiently; and a subsequent molding/decompression step of extruding a resin composition through a die arranged at a distal end of the extruder to thereby release the pressure (typically, to atmospheric pressure) to perform molding and foaming simultaneously. Optionally (where necessary), a heating step may be further provided to enhance cell growth by heating. After the cells are allowed to grow in this way, the resin composition is rapidly cooled with cold water as needed to fix its shape to yield the resin foam. Note that, in the kneading/impregnation step and molding/decompression step, an injection molding machine or the like may be used in addition to an extruder.

That is, the resin foam of the present invention may be formed by allowing it to expand through the steps of impregnating a molten resin composition with a high-pressure gas and then subjecting the impregnated resin composition to decompression. Further, the resin foam of the present invention may be formed through the steps of impregnating the molten resin composition with a high-pressure gas and then subjecting the impregnated resin composition to decompression, followed by heating the decompressed resin composition.

In the gas impregnation step in the batch system or in the kneading/impregnation system in the continuous system, the amount of the gas to be incorporated into the resin composition is not particularly limited, for example, the amount is preferably 1 to 10% by weight, more preferably 1.5 to 8% by weight, relative to the total amount of the resin composition.

In the gas impregnation step in the batch system or in the kneading/impregnation step in the continuous system, the pressure at which the unfoamed resin molded article or a resin composition is impregnated with a high-pressure gas is preferably not less than 3 MPa (for example, 3 to 100 MPa), more preferably not less than 4 MPa (for example, 4 to 100 MPa). If the pressure of the gas is lower than 3 MPa, considerable cell growth may occur during foaming, and this may tend to result in too large cell diameters and hence in disadvantages such as insufficient dustproofing effect. Therefore, the pressure of the gas lower than 3 MPa is not preferred. The reasons for this are as follows. When impregnation is performed at a low pressure, the amount of gas impregnated is relatively small and cell nuclei are formed at a lower rate as compared with impregnation at higher pressures. As a result, the number of cell nuclei formed is smaller. Because of this, the gas amount per cell increases rather than decreases, resulting in excessively large cell diameters. Furthermore, in a region of pressures lower than 3 MPa, only a slight change in impregnation pressure results in considerable changes in cell diameter and cell density, and this may often impede the control of cell diameter and cell density.

Further, in the gas impregnation step in the batch system or in the kneading/impregnation system in the continuous system, the temperature at which the unfoamed resin molded article or a polyester elastomer composition is impregnated with a high-pressure gas can be selected within a wide range. When impregnation operability and other conditions are taken into account, the impregnation temperature is preferably 10° C. to 350° C. For example, when an unfoamed resin molded article in a sheet form is impregnated with a high-pressure gas in the batch system, the impregnating temperature is preferably 40 to 300° C., more preferably 100 to 250° C. Further, when a high-pressure gas is injected into and kneaded with a resin composition in the continuous system, the impregnation temperature is preferably 150 to 300° C., more preferably 210 to 250° C. Note that when carbon dioxide is used as a high-pressure gas, it is preferred to impregnate the gas at a temperature (impregnation temperature) of 32° C. or higher (particularly 40° C. or higher), in order to maintain its supercritical state.

Note that, in the decompression step, the decompression rate is preferably 5 to 300 MPa/s in order to obtain uniform micro cells, but is not particularly limited thereto. Further, the heating temperature in the heating step is preferably 40 to 250° C., more preferably 60 to 250° C., but is not particularly limited thereto.

Further, a resin foam having a high expansion ratio can be produced according to the process for producing the resin foam, and therefore, a thick resin foam can be obtained. For example, when the resin foam is produced by the continuous system, it is necessary to regulate the gap in the die at the tip of the extruder so as to be as narrow as possible (generally 0.1 to 1.0 mm) for maintaining the pressure in the extruder in the kneading/impregnation step. This means that for obtaining a thick resin foam, a resin composition which has been extruded through such narrow gap should be foamed at a high expansion ratio. In the known techniques in use, however, a high expansion ratio is not obtained and the resulting foam has been limited to thin one (for example, one having a thickness of 0.5 to 2.0 mm). In contrast, the process for producing the resin foam using a high-pressure gas can continuously produce a resin foam having a final thickness of 0.30 to 5.00 mm.

Since the resin foam of the present invention has a thickness recovery ratio at high temperatures of not less than a specific value, an average cell diameter within a specific range, and a maximum cell diameter of not more than a specific value, the resin foam has a uniform and fine cell structure and is excellent in flexibility. Therefore, the resin foam can follow a fine clearance.

Further, since the resin foam of the present invention has a thickness recovery ratio at high temperatures of not less than a specific value, an average cell diameter within a specific range, and a maximum cell diameter of not more than a specific value, the resin foam is excellent in recoverability from deformation caused by the application of a strain even at high temperatures (for example, 10 to 100° C.) in addition to ordinary temperatures, and is excellent in dustproofness. Further, since the resin foam does not contain coarse cells, a problem of entry of dust from coarse cells to reduce dustproofness will not occur.

Since the resin foam of the present invention has the above characteristics, the resin foam can be used in applications in which the use of the resin foam in high-temperature environments is assumed. The resin foam of the present invention is suitably used as a sealing material and a dustproofing material for electric appliances, electronic appliances, or the like. Further, it is suitably used as a cushioning material and a shock absorber, particularly as a cushioning material and a shock absorber for electric appliances or electronic appliances.

### (Foam Material)

The resin foam of the present invention may be used as a foam material. That is, the foam material is a material comprising the resin foam of the present invention. The foam material may have a structure consisting only of the resin foam of the present invention, or may have a structure in which other layers (particularly, a pressure-sensitive adhesive layer (adhesive layer), a base material layer, and the like) are laminated to the resin foam.

The shape of the foam material is preferably a sheet form (including a film form) and a tape form, but is not particularly limited thereto. The foam material may be processed so as to have desired shape, thickness, and the like. For example, it may be processed to various shapes according to the apparatus, equipment, housing, member, and the like in which it is used.

In particular, the foam material preferably has a pressure-sensitive adhesive layer. For example, when the foam material is a foam material in a sheet form, it preferably has a pressure-sensitive adhesive layer on one side or both sides thereof. When the foam material has a pressure-sensitive adhesive layer, a mount for processing, for example, can be provided on the foam material through the pressure-sensitive adhesive layer, and the foam material can also be fixed or tentatively fixed to an object (for example, a housing, a part, or the like).

Examples of the pressure-sensitive adhesives for forming the pressure-sensitive adhesive layer include, but are not limited to, acrylic pressure-sensitive adhesives, rubber pressure-sensitive adhesives (such as natural rubber pressure-sensitive adhesives and synthetic rubber pressure-sensitive adhesives), silicone pressure-sensitive adhesives, polyester pressure-sensitive adhesives, urethane pressure-sensitive adhesives, polyamide pressure-sensitive adhesives, epoxy pressure-sensitive adhesives, vinyl alkyl ether pressure-sensitive adhesives, and fluorine pressure-sensitive adhesives. The pressure-sensitive adhesives may be used alone or in combination. Further, the pressure-sensitive adhesives may be pressure-sensitive adhesives of any form including emulsion pressure-sensitive adhesives, solvent pressure-sensitive adhesives, hot melt type adhesives, oligomer pressure-sensitive adhesives, and solid pressure-sensitive adhesives. Especially, acrylic pressure-sensitive adhesives are preferred as the pressure-sensitive adhesives from the point of view of the pollution control to adherends and the like. That is, the foam material preferably has an acrylic pressure-sensitive adhesive layer on the resin foam of the present inventions.

The thickness of the pressure-sensitive adhesive layer is preferably 2 to 100 μm, more preferably 10 to 100 μm, but is not particularly limited thereto. The pressure-sensitive adhesive layer is preferably as thin as possible because a thinner layer has a higher effect of preventing adhesion of soil and dust at an end. Note that the pressure-sensitive adhesive layer may have any form of a single layer and a laminate.

In the foam material, the pressure-sensitive adhesive layer may be provided through other layers (lower layers). Examples of such lower layers include other pressure-sensitive adhesive layers, an intermediate layer, an undercoat layer, and a base material layer (particularly a film layer, a nonwoven fabric layer, and the like). Further, the pressure-sensitive adhesive layer may be protected by a release film (separator) (such as a releasing paper and a release film).

Since the foam material comprises the resin foam of the present invention, it is excellent in flexibility. Further, the foam material has a flexibility that can follow fine clearance. Furthermore, the foam material is excellent in dustproofness at ordinary temperatures and high temperatures (for example, 10 to 100° C.)

Since the foam material has the characteristics as described above, it is suitably used as a material used for attaching (mounting) various members or parts to a predetermined site. In particular, the foam material is suitably used as a material used for attaching (mounting) parts constituting electric or electronic appliances to a predetermined site.

That is, the foam material is suitably used for electric or electronic appliances. That is, the foam material may be a foam material for electric or electronic appliances.

Examples of the various members or parts which can be attached (mounted) utilizing the foam material preferably include, but are not particularly limited to, various members or parts in electric or electronic appliances. Examples of such members or parts for electric or electronic appliances include optical members or optical components such as image display members (displays) (particularly small-sized image display members) which are mounted on image display devices such as liquid crystal displays, electroluminescence displays, and plasma displays, and cameras and lenses (particularly small-sized cameras and lenses) which are mounted on mobile communication devices such as so-called “cellular phones” and “personal digital assistants”.

Examples of suitable use modes of the foam material of the present invention include using it around a display such as LCD (liquid crystal display) and using by inserting it between a display such as LCD (liquid crystal display) and a housing (window part) for the purpose of dustproofing, shading, cushioning, or the like.

### EXAMPLES

Hereinafter, the present invention will be more specifically described with reference to Examples and Comparative Examples. However, the present invention is not at all limited thereto.

### Example 1

In a twin-screw kneader were kneaded, at a temperature of 220° C., 100 parts by weight of a block copolymer of polybutylene terephthalate as a hard segment and polyether as a soft segment (trade name “PELPRENE P-90BD” supplied by Toyobo Co., Ltd., melt flow rate at 230° C.: 3.0 g/10 min, melting point: 204° C.), 5 parts by weight of an acrylic lubricant (trade name “Metablen L-1000” supplied by Mitsubishi Rayon Co., Ltd.), 1 part by weight of hard clay surface-treated with a silane coupling agent (trade name “ST-301” supplied by Shiraishi Calcium Kaisha, Ltd.), 5 parts by weight of carbon black (trade name “Asahi #35” supplied by Asahi Carbon Co., Ltd.), and 2 parts by weight of an epoxy modifier (epoxy-modified acrylic polymer, weight average molecular weight (Mw): 50000, epoxy equivalent: 1200 g/eq, viscosity: 2850 mPa·s). The kneaded mixture was then extruded into strands, cooled with water, and formed into pellets by cutting.

The pellets were charged into a single-screw extruder, and carbon dioxide gas was injected at an atmospheric temperature of 240° C. and at a pressure of 17 MPa, where the pressure became 13 MPa after injection. The pellets were sufficiently saturated with the carbon dioxide gas, cooled to a temperature suitable for foaming, and extruded through a die, yielding a polyester elastomer foam in a sheet form having a thickness of 2.0 mm.

### Example 2

In a twin-screw kneader were kneaded, at a temperature of 220° C., 100 parts by weight of a block copolymer of polybutylene terephthalate as a hard segment and polyether as a soft segment (trade name “PELPRENE P-90BD” supplied by Toyobo Co., Ltd., melt flow rate at 230° C.: 3.0 g/10 min, melting point: 204° C.), 1 part by weight of an acrylic lubricant (trade name “Metablen L-1000” supplied by Mitsubishi Rayon Co., Ltd.), 1 part by weight of hard clay surface-treated with a silane coupling agent (trade name “ST-301” supplied by Shiraishi Calcium Kaisha, Ltd.), 5 parts by weight of carbon black (trade name “Asahi #35” supplied by Asahi Carbon Co., Ltd.), and 2 parts by weight of an epoxy modifier (epoxy-modified acrylic polymer, weight average molecular weight (Mw): 50000, epoxy equivalent: 1200 g/eq, viscosity: 2850 mPa·s). The kneaded mixture was then extruded into strands, cooled with water, and formed into pellets by cutting.

The pellets were charged into a single-screw extruder, and carbon dioxide gas was injected at an atmospheric temperature of 240° C. and at a pressure of 17 MPa, where the pressure became 13 MPa after injection. The pellets were sufficiently saturated with the carbon dioxide gas, cooled to a temperature suitable for foaming, and extruded through a die, yielding a polyester elastomer foam in a sheet form having a thickness of 2.0 mm.

### Example 3

In a twin-screw kneader were kneaded, at a temperature of 220° C., 100 parts by weight of a block copolymer of polybutylene terephthalate as a hard segment and polyether as a soft segment (trade name “PELPRENE P-90BD” supplied by Toyobo Co., Ltd., melt flow rate at 230° C.: 3.0 g/10 min, melting point: 204° C.), 5 parts by weight of an acrylic lubricant (trade name “Metablen L-1000” supplied by Mitsubishi Rayon Co., Ltd.), 3 parts by weight of hard clay surface-treated with a silane coupling agent (trade name “ST-301” supplied by Shiraishi, Calcium Kaisha, Ltd.), 5 parts by weight of carbon black (trade name “Asahi #35” supplied by Asahi Carbon Co., Ltd.), and 2 parts by weight of an epoxy modifier (epoxy-modified acrylic polymer, weight average molecular weight (Mw): 50000, epoxy equivalent: 1200 g/eq, viscosity: 2850 mPa·s). The kneaded mixture was then extruded into strands, cooled with water, and formed into pellets by cutting. The pellets were charged into a single-screw extruder, and carbon dioxide gas was injected at an atmospheric temperature of 240° C. and at a pressure of 17 MPa, where the pressure became 13 MPa after injection. The pellets were sufficiently saturated with the carbon dioxide gas, cooled to a temperature suitable for foaming, and extruded through a die, yielding a polyester elastomer foam in a sheet form having a thickness of 1.5 mm.

### Comparative Example 1

In a twin-screw kneader were kneaded, at a temperature of 200° C., 35 parts by weight of polypropylene (melt flow rate (MFR): 0.35 g/10 min), 60 parts by weight of a polyolefin elastomer (melt flow rate (MFR): 6 g/10 min), 5 parts by weight of polyethylene, 10 parts by weight of magnesium hydroxide (average particle size: 0.7 Tim), and 10 parts by weight of carbon black (trade name “Asahi #35” supplied by Asahi Carbon Co., Ltd.). The kneaded mixture was then extruded into strands, cooled with water, and formed into pellets by cutting.

The pellets were charged into a single-screw extruder supplied by Japan Steel Works, Ltd., and carbon dioxide gas was injected at an atmospheric temperature of 220° C. and at a pressure of 13 MPa, where the pressure became 12 MPa after injection. The mixture was sufficiently saturated with the carbon dioxide gas, cooled to a temperature suitable for foaming, and extruded through a die, yielding a polyolefin elastomer foam in a sheet form having a thickness of 2.1 mm.

### Comparative Example 2

In a twin-screw kneader were kneaded, at a temperature of 220° C., 100 parts by weight of a block copolymer of polybutylene terephthalate as a hard segment and polyether as a soft segment (trade name “Hytrel 5577” supplied by Du Pont-Toray Co., Ltd., melt flow rate at 230° C.: 1.8 g/10 min, melting point: 208° C.), 5 parts by weight of an acrylic lubricant (trade name “Metablen L-1000” supplied by Mitsubishi Rayon Co., Ltd.), 1 part by weight of polypropylene (trade name “NEWSTREN SH9000” supplied by Japan Polypropylene Corporation), 1 part by weight of magnesium hydroxide (average particle size: 0.7 μm), 5 parts by weight of carbon black (trade name “Asahi #35” supplied by Asahi Carbon Co., Ltd.), and 0.5 parts by weight of an epoxy crosslinking agent (trifunctional epoxy compound, trade name “TEPIC-G” supplied by Nissan Chemical Industries, Ltd., melting point: 90 to 125° C., epoxy equivalent: 110 g/eq, viscosity: not more than 100 cp, molecular weight: 297). The kneaded mixture was then extruded into strands, cooled with water, and formed into pellets by cutting.

The pellets were charged into a single-screw extruder, and carbon dioxide gas was injected at an atmospheric temperature of 240° C. and at a pressure of 17 MPa, where the pressure became 13 MPa after injection. The pellets were sufficiently saturated with the carbon dioxide gas, cooled to a temperature suitable for foaming, and extruded through a die, yielding a polyester elastomer foam in a sheet form having a thickness of 2.2 mm.

### (Evaluation)

Foams from Examples and Comparative Example were subjected to the following measurements or evaluations. Then, the results are shown in Table 1.

### (Apparent Density)

A foam was punched into a test piece in a sheet form with a punching blade die having a size of 20 mm in width and 20 mm in length. The dimension of the test piece was measured with a vernier caliper. Further, the thickness of the test piece was measured with a 1/100 dial gauge having a measuring terminal of 20 mm in diameter (φ). The volume of the test piece was calculated from these values. Next, the weight of the test piece was measured with an electronic balance. From the volume of the test piece and the weight of the test piece, the apparent density (g/cm³) of the foam was calculated by the following formula.

Apparent density of foam(g/cm³)=(weight of test piece)/(volume of test piece)

### (Repulsive Force at 50% Compression (Repulsive Load at 50% Compression, 50% Compressive Load))

The repulsive stress at 80% compression was measured according to the method for measuring a compressive hardness prescribed in JIS K 6767.

A foam was cut into a test piece in a sheet form having a size of 30 mm in width and 30 mm in length. Next, the test piece was compressed in the thickness direction at a rate of compression of 10 μm/min until the test piece was compressed to a compression ratio of 50% to determine the stress (N), which was converted to a value per unit area (1 cm²) to obtain a repulsive force (N/cm²).

### (Thickness Recovery Ratio at High Temperatures)

A foam was cut into a test piece in a sheet form having a size of 30 mm in width and 30 mm in length. The thickness of this test piece was measured accurately, and it was referred to as thickness a. Note that when the thickness of the test piece is less than 5 mm, the test pieces are stacked for use. Next, the test piece was compressed in the thickness direction from both surfaces of the test piece with two compression plates (aluminum sheets) using a jig so that the test piece had a thickness of 20% of the initial thickness (that is, 80% compression state), and the test piece was stored for 22 hours under conditions of a humidity of 50% and a temperature of 80° C. while maintaining the compression state. After the lapse of 22 hours, the test piece was released from the compression state in an atmosphere of 23° C. and allowed to stand for 24 hours. After allowing the test piece to stand, the thickness of the test piece was accurately measured, and it was referred to as thickness b.

Using the thickness a and the thickness b, the thickness recovery ratio (%) at high temperatures was calculated from the following formula.

Thickness recovery ratio at high temperatures(%)=(thickness b/thickness a)×100

Note that the thickness a and the thickness b were measured in an environment of a temperature of 23±2° C. and a relative humidity of 50±5%.

### (Average Cell Diameter, Maximum Cell Diameter)

The cell diameter (μm) of each cell was determined by capturing an enlarged image of a foam cell portion using a digital microscope (trade name “VHX-500” supplied by Keyence Corporation) and analyzing the captured image using the analysis software of this measuring instrument. Then, the average cell diameter (μm) and the maximum cell diameter (μm) were determined from the cell diameter of each cell. The number of the cells in the captured enlarged image is about 200 pieces. Note that the cell diameter was obtained by determining the area of a cell and converting it to the equivalent circle diameter.

### (Dustproofness at 23° C.)

The measurement of dustproofness of a foam was performed according to the evaluation method of dynamic dustproofness in Japanese Patent Laid-Open No. 2011-162717. The measurement of the dustproofness was performed for the case where the compression ratio of a foam was 50%. Further, the temperature during measurement was 23° C.

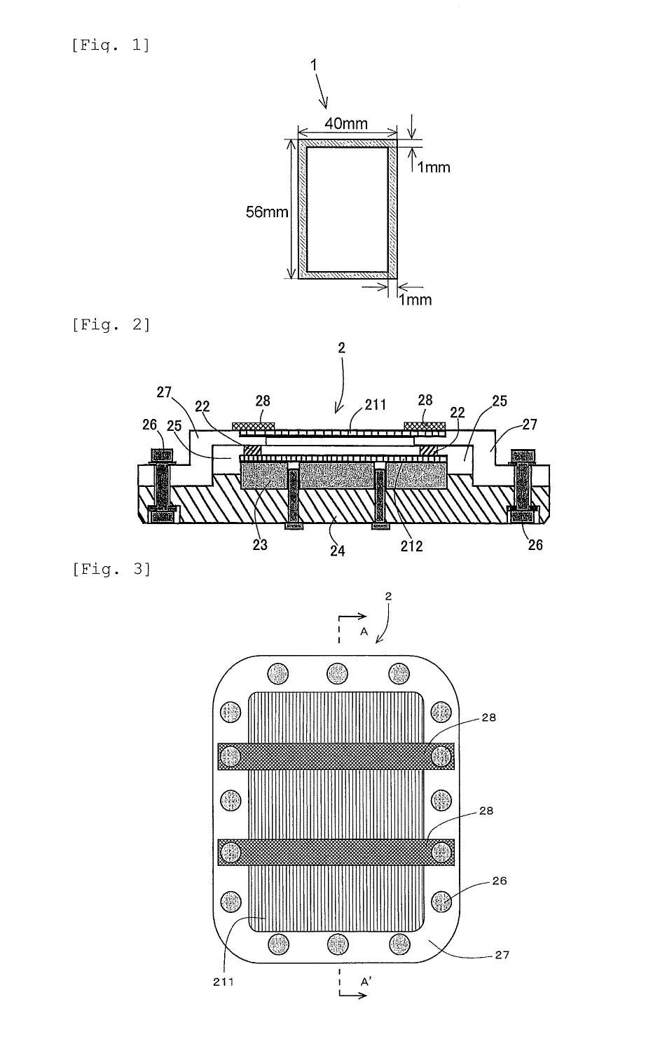

Specifically, the measurement was performed as follows. A foam was punched into a frame shape (a window-frame shape) (width: 1 mm) as shown in FIG. 1 to prepare a sample for measurement.

The sample for measurement was mounted on an evaluation container (refer to FIGS. 2 and 3) so that the sample for measurement was compressed in the thickness direction into a state where the sample had a thickness of 50% of the initial thickness (50% compression state). As shown in FIG. 2, the sample for measurement is provided between a foam compression plate and a black acrylic sheet on an aluminum sheet fixed to a base plate. In the evaluation container on which the sample for measurement is mounted, the sample for measurement forms a closed system in a certain area inside the container.

After the sample for measurement was mounted on the evaluation container, 0.1 g of cornstarch (particle size: 17 μm) as powder dust was put into a powder supply part of the evaluation container, and the evaluation container was placed in a drum-type drop tester (rotating drop apparatus), which was rotated at a rate of 1 rpm.

Then, the tester was rotated by a specified number of times so as to obtain a target number of times of collision, and then the number of particles (dust, cornstarch) was measured which entered the inner part of the evaluation container from the powder supply part passing through the sample for measurement.

The number of particles which entered the inner part of the evaluation container was determined by observing the particles adhering to a black acrylic sheet on the aluminum sheet and a black acrylic sheet as a cover plate with a microscope, preparing static images of the black acrylic sheet on the side of the aluminum sheet and the black acrylic sheet on the side of the cover plate, subjecting these images to binarization with image analysis software, determining the number of respective particles, and totaling the number of particles. Note that the observation was performed in a clean bench in order to reduce the influence of floating dust in the air.

### (Dustproofness at 80° C.)

In the same manner as in the case of the “Dustproofness at 23° C.,” an evaluation container on which a sample was mounted and in which cornstarch was charged was stored in a high-temperature environment of 80° C. for 22 hours. After storage, the evaluation container was allowed to stand in an ordinary temperature environment for 2 hours and then subjected to the measurement of dustproofness. The temperature during measurement was 23° C.

Note that the dustproofness index is preferably not more than 100,000, more preferably not more than 50,000, in terms of increasing dustproofness.

### (Melt Tension)

Capillary Extrusion Rheometer supplied by Malvern Instruments Ltd. was used for the measurement of melt tension, and a tension when a resin extruded at a constant speed of 8.8 mm/min from a capillary having a diameter of 2 mm and a length of 20 mm was taken up at a take-up speed of 2 m/min was defined as melt tension.

Note that pellets before foam molding were used for measurement. In addition, the temperature at the measurement was a temperature that was higher by 10±2° C. than the melting point of the resin.

### (Degree of Strain Hardening)

Pellets before foam molding were used for the measurement. The pellets were formed into a sheet form having a thickness of 1 mm using a heated hot plate press, thus obtaining a sheet. A sample (10 mm in length, 10 mm in width, 1 mm in thickness) was cut from the sheet.

Using the sample, the uniaxial elongational viscosity at a strain rate of 0.1 [1/s] was measured using a uniaxial elongational viscometer (supplied by TA Instruments Corp.). Then, the degree of strain hardening was determined by the following formula.

Degree of strain hardening=log ηmax/log η0.2

(ηmax shows the highest elongational viscosity in the measurement of the uniaxial elongational viscosity, and η0.2 shows the elongational viscosity at a strain Σ of 0.2.)

Note that the temperature at the measurement was the melting point of the resin.

TABLE 1

| | Example | Example | Example | Comparative | Comparative |
|---|---|---|---|---|---|
| | 1 | 2 | 3 | Example 1 | Example 2 |
| Apparent density | 0.070 | 0.075 | 0.090 | 0.060 | 0.085 |
| (g/cm³) | | | | | |
| Repulsive force at | 2.2 | 2.3 | 2.5 | 1.2 | 2.7 |
| 50% compression | | | | | |
| (N/cm²) | | | | | |
| Thickness | 51 | 48 | 47 | 21 | 50 |
| recovery ratio at | | | | | |
| high temperatures | | | | | |
| (%) | | | | | |
| Average cell | 70 | 80 | 60 | 100 | 100 |
| diameter | | | | | |
| (μm) | | | | | |
| Maximum cell | 160 | 160 | 84 | 160 | 390 |
| diameter | | | | | |
| (μm) | | | | | |
| Dustproofness at | 56,000 | 12,000 | 10,000 | 374,000 | 115,000 |
| 23° C. | | | | | |
| (pieces) | | | | | |
| Dustproofness at | 54,000 | 13,000 | 11,000 | 715,000 | 121,000 |
| 80° C. | | | | | |
| (pieces) | | | | | |
| Melt tension | 27 | 42 | 29 | — | 13 |
| (cN) | | | | | |
| Degree of strain | 4.12 | 3.56 | 3.01 | — | 1.34 |
| hardening | | | | | |

### INDUSTRIAL APPLICABILITY

The resin foam and the foam material of the present invention are excellent in recoverability at high temperatures, have excellent dustproofness at ordinary temperatures, and are also excellent in dustproofness after storage in high-temperature environments. Therefore, the resin foam and the foam material of the present invention are suitably used for electric or electronic appliances.

### REFERENCE SIGNS LIST

1 Sample for measurement
2 Evaluation Container on which sample for measurement is mounted
211 Black acrylic sheet (black acrylic sheet on the side of cover plate)
212 Black acrylic sheet (black acrylic sheet on the side of aluminum sheet)
22 Sample for measurement
23 Aluminum sheet
24 Base plate
25 Powder supply part
26 Screw
27 Foam compression plate
28 Cover plate-fixing bracket

1. A resin foam having a thickness recovery ratio at high temperatures as defined below of not less than 25%, an average cell diameter of 10 to 200 μm, and a maximum cell diameter of not more than 300 μm,
wherein the thickness recovery ratio at high temperatures is defined as follows: a resin foam in a sheet form is compressed, in an atmosphere of 80° C., for 22 hours in a thickness direction so as to have a thickness of 20% of the initial thickness; then, the compression state is released in an atmosphere of 23° C.; and a ratio of a thickness 24 hours after the release of the compression state to the initial thickness is defined as the thickness recovery ratio at high temperatures.

2. The resin foam according to claim 1, wherein the resin foam has an apparent density of 0.01 to 0.20 g/cm³ and a repulsive force at 50% compression of 0.1 to 4.0 N/cm².

3. The resin foam according to claim 1, wherein a resin constituting the resin foam is a thermoplastic resin.

4. The resin foam according to claim 3, wherein the thermoplastic resin is polyester.

5. The resin foam according to claim 1, wherein the resin foam is formed through the steps of impregnating the resin composition with a high-pressure gas and then subjecting the impregnated resin composition to decompression.

6. The resin foam according to claim 5, wherein the resin foam is formed through the steps of impregnating an unfoamed molded article comprising the resin composition with a high-pressure gas and then subjecting the impregnated unfoamed molded article to decompression to allow the unfoamed molded article to expand.

7. The resin foam according to claim 5, wherein the resin foam is formed through the steps of impregnating a molten resin composition with a high-pressure gas and then subjecting the impregnated resin composition to decompression to allow the resin composition to expand.

8. The resin foam according to claim 5, wherein the resin foam is formed by the steps of impregnating a resin composition with a high-pressure gas and then subjecting the impregnated resin composition to decompression, followed by further heating.

9. The resin foam according to claim 5, wherein the gas is an inert gas.

10. The resin foam according to claim 5, wherein the gas is carbon dioxide gas.

11. The resin foam according to claim 5, wherein the high-pressure gas is a gas in a supercritical state.

12. A foam material comprising a resin foam according to claim 1.

13. The foam material according to claim 12, wherein the foam material has a pressure-sensitive adhesive layer on the resin foam.

14. The foam material according to claim 13, wherein the pressure-sensitive adhesive layer is formed on the resin foam through a film layer.

15. The foam material according to claim 13, wherein the pressure-sensitive adhesive layer is an acrylic pressure-sensitive adhesive layer.
